(19) United States
(12) Patent Application Publication
(10) Pub. No.: US 2025/0279952 A1
(43) Pub. Date: Sep. 4, 2025

(54) METHOD AND SYSTEM FOR WORKLOAD MANAGEMENT OF NFV-MANO FUNCTIONAL ENTITIES

(71) Applicants: Maria TOEROE, Montreal (CA); TELEFONAKTIEBOLAGET LM ERICSSON (PUBL), Stockholm (SE)

(72) Inventor: Maria Toeroe, Montreal (CA)

(73) Assignee: TELEFONAKTIEBOLAGET LM ERICSSON (PUBL), Stockholm (SE)

(21) Appl. No.: 18/034,309

(22) PCT Filed: Nov. 12, 2021
(86) PCT No.: PCT/IB2021/060519

§ 371 Date: Apr. 27, 2023

Related U.S. Application Data
(60) Provisional application No. 63/118,805, filed on Nov. 27, 2020.

(51) Int. Cl. H04L 43/20; H04L 41/0897; H04L 43/16

(52) U.S. Cl. CPC H04L 43/20; H04L 41/0897; H04L 43/16

(57) ABSTRACT

The disclosure relates to a method, apparatus and computer readable media for workload management. The method is executed by a service provider (SP) Network Function Virtualization Management and Orchestration (NFV-MANO) functional entity (FE) (SP FE). The method comprises receiving a request for an NFV-MANO service from an NFV-MANO service user (SU). The method comprises upon detecting that a threshold indicative of a state of a workload of the SP FE is crossed, determining a priority of the request for the NFV-MANO service and determining, based on the priority and the workload of the SP FE, whether to accept or reject the request. The method comprises sending a response to the SU indicative of whether the request is accepted or rejected.

### PRIORITY STATEMENT UNDER 35 U.S.C. S.119(E) & 37 C.F.R. S.1.78

This non-provisional patent application claims priority based upon the prior U.S. provisional patent application entitled “METHOD AND SYSTEM FOR WORKLOAD MANAGEMENT OF NFV-MANO FUNCTIONAL ENTITIES”, application No. 63/118,805, filed Nov. 27, 2020, in the names of Maria Toeroe.

### TECHNICAL FIELD

The present disclosure relates to the management and operation of Network Function Virtualization Management and Orchestration (NFV-MANO) functional entities.

### BACKGROUND

The workload handled by NFV-MANO functional entities can vary over time. Increased load can happen due to legitimate (e.g. disaster) or illegitimate (e.g. Distributed Denial-of Service (DDOS) attack) causes. In either case, it is essential that the NFV-MANO functional entities remain in control of the NFV system they are managing and be able to provide their services, i.e. interact with their peers and the entities they manage in a timely fashion.

To achieve this, the NFV-MANO functional entities need to be prepared to handle workload fluctuations and cope with potentially adverse increases in workload.

### SUMMARY

There is provided a method for workload management, executed by a service provider (SP) Network Function Virtualization Management and Orchestration (NFV-MANO) functional entity (FE) (SP FE). The method comprises receiving a request for an NFV-MANO service from an NFV-MANO service user (SU). The method comprises, upon detecting that a threshold indicative of a state of a workload of the SP FE is crossed, determining a priority of the request for the NFV-MANO service and determining, based on the priority and the workload of the SP FE, whether to accept or reject the request. The method comprises sending a response to the SU indicative of whether the request is accepted or rejected.

There is provided an apparatus executing a service provider (SP) Network Function Virtualization Management and Orchestration (NFV-MANO) functional entity (FE) (SP FE) operative to execute workload management. The apparatus comprises processing circuits and a memory, the memory contains instructions executable by the processing circuits whereby the apparatus is operative to receive a request for an NFV-MANO service from an NFV-MANO service user (SU). The apparatus is operative to, upon detecting that a threshold indicative of a state of a workload of the SP FE is crossed, determine a priority of the request for the NFV-MANO service and determine, based on the priority and the workload of the SP FE, whether to accept or reject the request. The apparatus is operative to send a response to the SU indicative of whether the request is accepted or rejected.

There is provided a non-transitory computer readable media having stored thereon instructions for workload management, executed by a service provider (SP) Network Function Virtualization Management and Orchestration (NFV-MANO) functional entity (FE) (SP FE). The instructions comprise receiving a request for an NFV-MANO service from an NFV-MANO service user (SU). The instructions comprise, upon detecting that a threshold indicative of a state of a workload of the SP FE is crossed, determining a priority of the request for the NFV-MANO service and determining, based on the priority and the workload of the SP FE, whether to accept or reject the request. The instructions comprise sending a response to the SU indicative of whether the request is accepted or rejected.

The method, apparatus and computer readable media provided herein present improvements to workload management of Network Function Virtualization Management and Orchestration (NFV-MANO) systems.

### BRIEF DESCRIPTION OF THE DRAWINGS

FIG. 1 is a graph illustrating the relation between different thresholds and the capacity of an NFV-MANO functional entity in relation to the workload and the resulting operational state of the NFV-MANO functional entity.

FIG. 2 is a schematic illustration of an example logic to control the workload of NFV-MANO functional entities.

FIG. 3 is a sequence diagram showing an example of overload handling.

FIG. 4 is a flowchart of a method for workload management.

FIG. 5 is a schematic illustration of a virtualization environment in which the different method(s), apparatus(es) and/or system(s) described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

In cloud systems, and accordingly for Virtualized Network Functions (VNFs) and Network Services (NSs), the primary method of handling workload fluctuations is scaling. That is, the workload is monitored, for example, using Performance Management (PM) jobs, and (auto-) scaling is triggered whenever the load crosses a given threshold. This approach can be applicable to NFV-MANO functional entities in a similar manner.

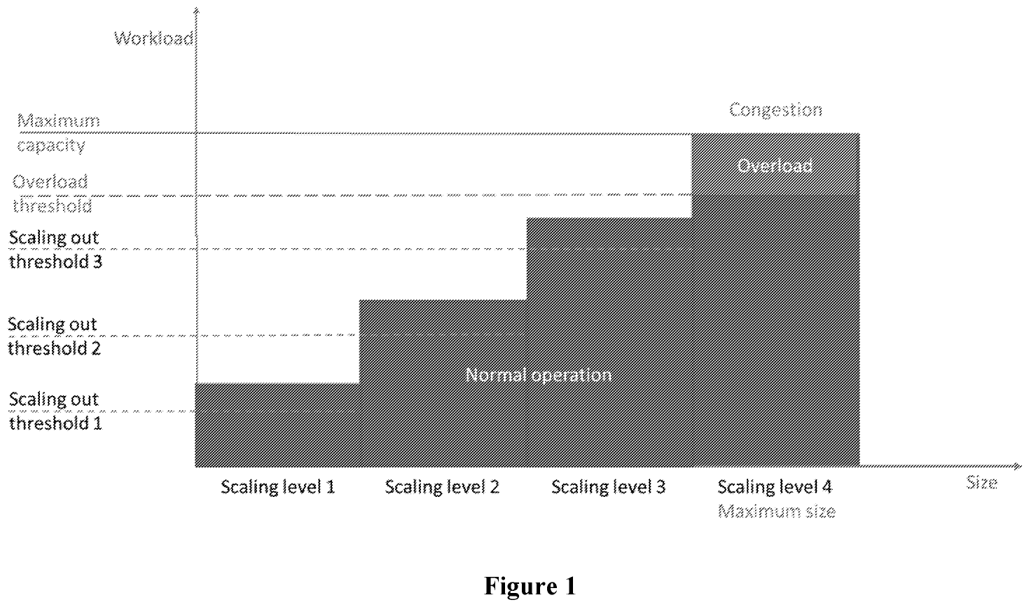

FIG. 1 illustrates the relation between the different thresholds and the capacity of an NFV-MANO functional entity in relation to the workload and the resulting operational state of the NFV-MANO functional entity. Operational states illustrated in the figure are: normal operation, overload and congestion.

As shown in the example in FIG. 1, this means that in normal operation the NFV-MANO functional entity is scaled out if the workload increases beyond a threshold set according to the current size/capacity of the NFV-MANO functional entity, i.e. scaling out threshold. This workload increase can be detected, for instance, by using a PM job. When the workload decreases again, the NFV-MANO functional entity can be scaled in.

However, there might be limits to the extent to which an NFV-MANO functional entity can be scaled. Moreover, some NFV-MANO functional entity implementations might not be scalable at all. In both cases, there is a maximum workload that the NFV-MANO functional entity is able to handle, i.e. it has a maximum capacity. If this capacity is reached, the NFV-MANO functional entity will not be able to cope with the workload it is receiving and it will become congested, its input buffers and job queues will overflow, so by the time requests are served they may have timed out. Eventually, the system might collapse all together. In such a situation, the main goal is to relieve the NFV-MANO functional entity from the congestion as soon as possible and return it to normal operation.

To avoid the negative effects of such congestion, proactive actions should be taken before the maximum capacity is reached. Therefore, a threshold below the maximum capacity can be defined, i.e. the overload threshold of FIG. 1. When reaching this overload threshold, the sub-system for which the threshold was defined is considered to be in the overload state.

At this time, i.e. in the overload state, the NFV-MANO functional entity is still capable of performing actions, provide feedback, prioritization, etc. in an attempt to reduce its workload in a (as much as possible) graceful manner. Different measures could be engaged simultaneously or in an escalation and, if successful, these measures might reduce the workload so that the NFV-MANO functional entity is able to cope with the overload.

Examples of NFV-MANO functional entities include virtual network functions manager (VNFM) and NFV orchestrator (NFVO). These entities are responsible for the life cycle management of entities, such as virtual network functions (VNF) and network services (NSs) respectively. They also perform the related fault management, performance management and similar tasks referred to as NFV-MANO services.

Traditional systems were not scalable and therefore handling of overload situations was typically based on a single threshold, which was configured in advance based on the maximum capacity. Reaching this threshold triggered predefined mechanisms built into the system. This approach was rigid.

In cloud-based systems, scaling and load balancing are the main solutions to handling overload. This is a very flexible approach; however, it may not always be applicable: there could be limits to the scaling due to implementation limits, licensing, or some parts of a system may not be scalable at all.

When an NFV-MANO functional entity is in the overload state, it might not be able to handle all the incoming requests. However, it might still have some capacity to handle urgent or important requests, which means the NFV-MANO functional entity needs to decide which requests it is going to execute and which ones it is going to reject with an appropriate return code (e.g., HTTP 429 Too Many Requests). Accordingly, the overload threshold could be associated with a policy to be used to determine the priority of the different requests possible based on the priority of the requesting entity and/or the operation being requested. Based on the determined priority and its actual workload, the NFV-MANO functional entity can determine the applicable reaction (i.e. accept or reject). Alternatively, the logic used behind the policy itself can determine the applicable reaction and provide it to the NFV-MANO functional entity in response to the inputs of the priority of the requesting entity, the requested operation, the current workload and/or other relevant information.

Table 1 describes the actors and roles for a use case.

TABLE 1
Overload handling actors and roles

| # | Role | Description |
|---|---|---|
| 1 | Service Provider | The service provider (SP) NFV-MANO functional entity |
| | FE | (FE) providing the NFV-MANO Service to become |
| | | overloaded |
| 2 | High Priority SU | An NFV-MANO service user (SU) requesting the NFV- |
| | | MANO Service with higher priority (HP) (see note). |
| 3 | Low Priority SU | An NFV-MANO service user (SU) requesting the NFV- |
| | | MANO Service with lower priority (LP) (see note). |
| 4 | Existing SU | An NFV-MANO service user (SU) which has an ongoing |
| | | request with the Service Provider FE for the NFV-MANO |
| | | Service. |
| 5 | MANO-Monitor | A management entity that has started a PM job on the |
| | | Service Provider FE and that is registered to receive |
| | | notifications about related threshold crossings. |
| 6 | NFV-MANO | The service offered by the Service Provider FE, for which |
| | Service | the MANO-Monitor has set up an overload threshold. |

NOTE:
The priority of a request could depend on among others the priority of the service user, the type of the requested operation, or their combination.

Table 2 describes the use case pre-conditions.

TABLE 2
Overload handling pre-conditions

| # | Pre-condition | Additional description |
|---|---|---|
| 1 | The Service Provider FE | The workload associated with NFV-MANO |
| | is operating correctly and | Service that the SP NFV-MANO functional entity |
| | has a PM job started with | offers is being monitored by a PM job for which |
| | a threshold for overload | the overload threshold has been set up including an |
| | defined and a policy | associated policy. |
| | associated. | |
| 2 | The policy determining | The SP NFV-MANO functional entity has the |
| | the prioritization of | information about the policy applicable at the |
| | requests under overload | crossing of the overload threshold, i.e. when in |
| | condition is known and | overload state. Using this policy, the SP NFV- |
| | has been associated with | MANO functional entity is capable of determining |
| | the PM job threshold | the priority of new incoming requests and the |
| | | applicable reaction. The priority could depend on |
| | | among others the priority of the service user, the |
| | | type of the requested operation, or their |
| | | combination. The applicable reaction can depend |
| | | on the current workload associated with NFV- |
| | | MANO Service. |
| 3 | The MANO-Monitor has | The MANO-Monitor has started a PM job on an |
| | subscribed to receive | NFV-MANO Service offered by the SP NFV- |
| | threshold crossing | MANO functional entity, and it has set up an |
| | notifications | overload threshold with an associated policy which |
| | | determines the priority of incoming requests and |
| | | their handling. |

Table 3 describes the use case post-conditions.

Table 3 describes the use case post-conditions

| | | |
|---|---|---|
| # | Post-condition | Additional description |

| | |
|---|---|
| 1 | The workload of the Service Provider FE is below |
| | the overload threshold |
| 2 | The Service Provider FE accepts valid requests for |
| | the NFV-MANO Service from any service user |

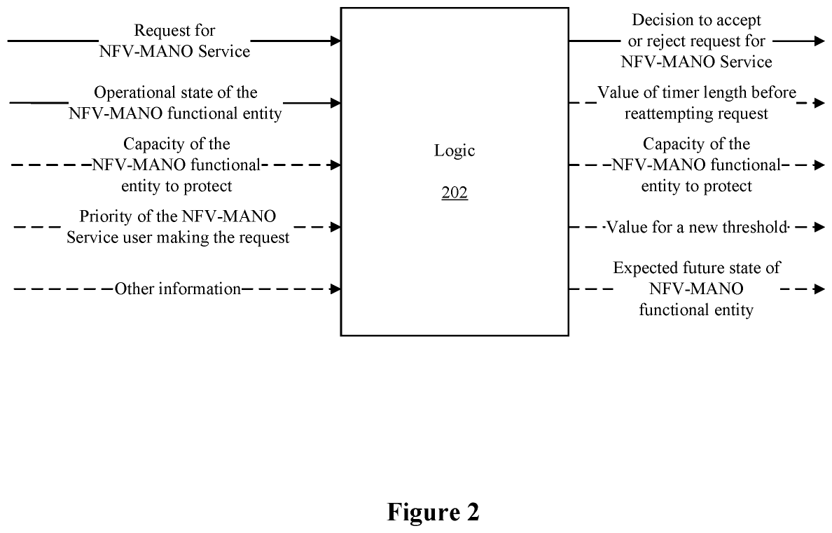

One example of the proposed logic 202 is illustrated in FIG. 2. FIG. 2 is provided as an example and different inputs/outputs could alternatively be selected. The logic 202 includes (provides) the NFV-MANO functional entities with appropriate reactions to control the workload of NFV-MANO functional entities. The logic is associated with a threshold, such as the overload threshold, through the policy which is used to evaluate the situation for each request once the threshold is crossed. The logic determines the priority of each request and accordingly the appropriate reaction. The priority could be based on, among others, an assigned priority of the requesting entity (e.g. VNF of a high priority NS), the Key Performance Indicator (KPI) associated with the request (e.g. VNF providing high-availability service), the type of the request (e.g. healing is more important than scaling), or any combination thereof. The reaction, whether the request is accepted or rejected, may depend on the relation of the current load to the maximum load, e.g. the closer the load is to the maximum, the higher is the priority cut off value for the requests to be accepted. Requests could also be accepted based on the type of service or the priority of the actual service. For example, some VNFs, network services and or network slices could have higher priority that would be known through the policy or through external data provided to the system. Further, requests could be accepted based on a combination of factors increasing the priority of some services e.g. a network service that needs healing could be prioritized over a network service that wants to scale out.

Further, the policy could also be escalating with the amount of overload (i.e. becoming more restrictive as the overload increases). For example, when the overload has just started and is still small, more requests could be accepted and as the overload increases, less and less new requests could be accepted, with criteria that are harder to meet. Another possibility could be that the logic evaluates the impact a request will have on the congestion and allow some low priority requests with very little impact on the congestion (short time to run and low capacity needed), while rejecting requests with high priority that take a very long time to execute or that use a lot of capacity.

This logic 202 may be implemented as a simple policy, a script or may be based on a behavior learnt over time, e.g. using Machine Learning (ML) techniques.

The logic may range from being very simple and fixed (such a predefined script) taking into account few criteria, to being very complex and taking into account many criteria including specific information concerning the entities or services making the requests and any other relevant information. A complex logic could be based on machine learning techniques in which previous states, requests, and associated data could be fed to a neural network, which could in turn provide a decision to accept or reject a request, as well as other output such as suggested durations for timers for retrying to get the request processed. For the latter, the ML technique could learn a typical length of time it usually takes to process a request or different requests in given conditions of the system and according to the overload state of the functional entity. The ML technique could also learn how much capacity needs to be protected for the functional entity to be able to continue processing some high priority requests, in different conditions of congestion. Or it could produce new thresholds to apply, for example for scale out decisions.

Advantages of this solution include that associating a logic with a threshold allows for a flexible implementation for overload handling, which can be fine-tuned to the situation: incoming requests can be prioritized according to simple or more complex criteria and the acceptance and rejection rate can be adjusted based on the relation of the current workload to the maximum workload and its changes over time, e.g. analytics and/or machine learning. Similar logic could apply to both thresholds illustrated in FIG. 1, namely the scaling out thresholds and the overload threshold.

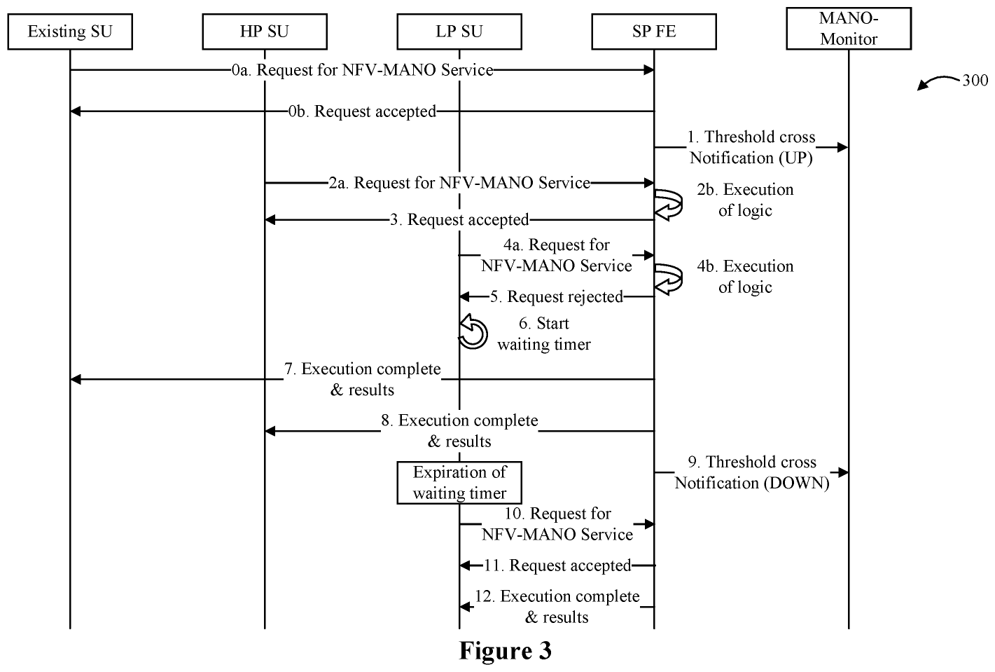

FIG. 3 illustrates an example flow 300 for handling an overload situation.

Table 4 describes the flow of the use case of FIG. 3, according to which the service provider NFV-MANO functional entity (Service Provider Functional Entity) has reached the overload state for the NFV_MANO Service by executing requests from different service users (SUs) (including Existing SU). As a result, subsequent requests are evaluated first according to the policy associated with the overload threshold. Requests evaluated as higher priority (coming from High Priority SU) are accepted for execution, while requests evaluated as lower priority (coming from Low Priority SU) are rejected with an appropriate return code. Once the execution of some of the ongoing requests completes, the workload of the SP FE for the NFV-MANO Service drops below the overload threshold.

TABLE 4
Overload handling flow description

| # | Actor/Role | Action/Description |
|---|---|---|
| Begins | Existing SU −> | The Service Provider FE has received a request from |
| when | Service Provider | the Existing SU for the NFV-MANO Service, which |
| (step 0) | FE | was accepted, and the SP FE has started to execute |
| | | the requested operation. With the acceptance of the |
| | | request, the Service Provider FE determines that it |
| | | has crossed the overload threshold for the PM job |
| | | and now it is in the overload state. The SP FE |
| | | identifies the policy related to the overload |
| | | threshold. |
| Step 1 | Service Provider | The Service Provider FE sends a threshold crossed |
| | FE −> MANO- | notification with direction UP to the MANO- |
| | Monitor | Monitor and any other entity subscribing for such |
| | | notifications (see note). |
| Step 2 | High Priority | The Service Provider FE receives a request from the |
| | SU −> Service | High Priority SU for the NFV-MANO Service. The |
| | Provider FE | Service Provider FE evaluates the priority of the |
| | | request using the policy associated with the overload |
| | | threshold and determines that it has high priority. |
| | | Therefore, it needs to be accepted and executed. |
| Step 3 | Service Provider | In its response the Service Provider FE indicates that |
| | FE −> High | the request of the High Priority SU has been |
| | Priority SU | accepted and is being executed. |
| Step 4 | Low Priority | The Service Provider FE receives a request from the |
| | SU −> Service | Low Priority SU for the NFV-MANO Service. The |
| | Provider FE | Service Provider FE evaluates the priority of the |
| | | request using the policy associated with the overload |
| | | threshold and determines that it has lower priority. |
| | | Therefore, it needs to be rejected. |
| Step 5 | Service Provider | In its responds to the Low Priority SU the Service |
| | FE −> Low | Provider FE indicates that the request has been |
| | Priority SU | rejected due to overload and indicates that the |
| | | request can be repeated at a later time. |
| Step 6 | Low Priority SU | The Low Priority SU starts a waiting timer as |
| | | indicated in the received rejection response. |
| Step 7 | Service Provider | The Service Provider FE has completed the |
| | FE −> Existing | execution of the operation associated with the |
| | SU | request of the Existing SU. The Service Provider FE |
| | | sends the results to the Existing SU. The workload |
| | | of the Service Provider FE remains above the |
| | | overload threshold. |
| Step 8 | Service Provider | The Service Provider FE has completed the |
| | FE −> High | execution of the operation associated with the |
| | Priority SU | request of the High Priority SU. The Service |
| | | Provider FE sends the results to the High Priority |
| | | SU. With this the workload of the Service Provider |
| | | FE drops below the overload threshold. |
| Step 9 | Service Provider | The Service Provider FE sends a threshold crossed |
| | FE −> MANO- | notification with direction DOWN to the MANO- |
| | Monitor | Monitor and any other entity subscribing for such |
| | | notifications (see note). |
| Step 10 | Low Priority | After the expiration of the waiting timer the Low |
| | SU −> Service | Priority SU resends its request for the NFV-MANO |
| | Provider FE | Service to the Service Provider FE. The Service |
| | | Provider FE is no longer in the overload state and |
| | | therefore accepts the request. |
| Ends | Service Provider | The Service Provider FE sends a response to the |
| when | FE −> Low | Low Priority SU indicating that the request has been |
| (Step 11) | Priority SU | accepted and the Service Provider FE starts the |
| | | execution of the requested operation. |

NOTE:
The Existing SU, High Priority SU and Low Priority SU might be among the subscribers for the threshold crossing notifications.

Step 12 is illustrated in FIG. 3, but not included in the table 4, in this step, the Service Provider FE has completed the execution of the operation associated with the request of the Low Priority SU. The Service Provider FE sends the results to the Low Priority SU.

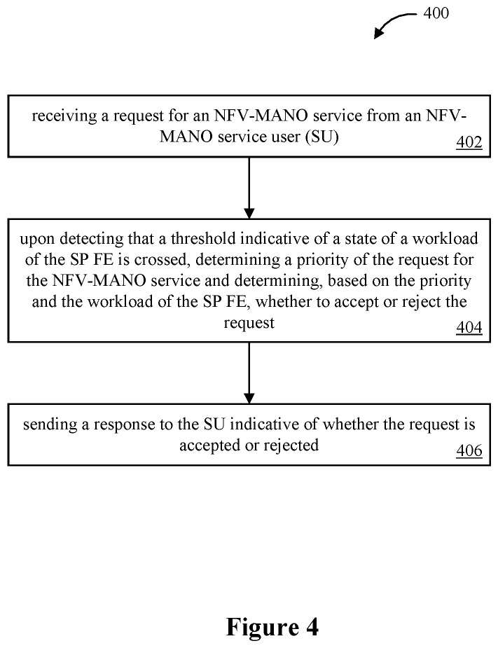

FIG. 4 illustrates a method 400 for workload management, executed by a service provider (SP) Network Function Virtualization Management and Orchestration (NFV-MANO) functional entity (FE) (SP FE), comprising:
Receiving, step 402, a request for an NFV-MANO service from an NFV-MANO service user (SU);
upon detecting that a threshold indicative of a state of a workload of the SP FE is crossed, determining, step 404, a priority of the request for the NFV-MANO service and determining, based on the priority and the workload of the SP FE, whether to accept or reject the request; and
sending, step 406, a response to the SU indicative of whether the request is accepted or rejected.

The threshold indicative of the state of the workload may be set in advance.

The threshold indicative of a state of a workload of the SP FE may be a threshold used for determining if the SP FE is in a state of overload.

The threshold indicative of a state of a workload of the SP FE may be a threshold used for determining if a scale out is warranted. The logic may be used to determine whether to accept or reject the request until a scale out has completed.

The threshold may be a set of thresholds and may comprise thresholds used for determining if a scale out is warranted, which may be associated with different scaling levels, the set of thresholds may also comprise the threshold used for determining if the SP FE is in a state of overload.

Determining the priority of the request may comprise determining that the request has a high priority or a low priority. The determination of the priority may be made using a priority scale.

The output of determining the priority and determining whether to accept or reject the request may take the form of a single (binary or non-binary) value, of a vector of values, or of any other suitable data structure.

The determining the priority of the request and determining whether to accept or reject the request may depend on a priority of the SU, a type of the requested service or operation, or their combination.

The determining may also depend on how close the workload is to a maximum load. An escalation mechanism may be in place so that the closer the workload is to the maximum the higher is the priority cut off value is for the requests to be accepted. The escalation mechanism may also increase the number of rejected requests with increasing workload, or increasingly reject request needing a high capacity as the workload approaches the maximum load.

The determining step may comprise producing a predicted time to run for the service request, a predicted capacity that needs to be protected, or other related data, which may be used in determining whether to accept or reject the request.

The priority may be determined using a logic which may take the form of a policy, script, a decision tree, or it may be based on the result of machine learning algorithm, e.g. using an artificial neural network, etc.

The logic for determining the priority of the request may produce a value for a timer, that may be sent to a SU along with a response indicative that the request was rejected. The timer may be used by the SU as a delay before trying to send the request again to the SP FE.

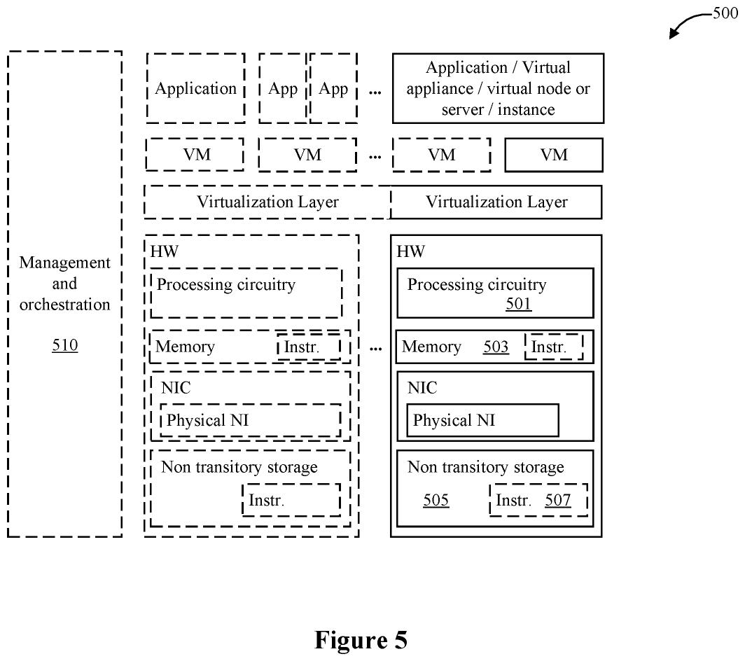

Referring to FIG. 5, there is provided a virtualization environment 500 in which functions and steps described herein can be implemented.

A virtualization environment (which may go beyond what is illustrated in FIG. 5), may comprise systems, networks, servers, nodes, devices, etc., that are in communication with each other either through wire or wirelessly. Some or all of the functions and steps described herein may be implemented as one or more virtual components (e.g., via one or more applications, components, functions, virtual machines or containers, etc.) executing on one or more physical apparatus in one or more networks, systems, environment, etc.

A virtualization environment provides hardware comprising processing circuitry 501 and memory 503. The memory can contain instructions executable by the processing circuitry whereby functions and steps described herein may be executed to provide any of the relevant features and benefits disclosed herein.

The hardware may also include non-transitory, persistent, machine readable storage media 505 having stored therein software and/or instruction 507 executable by processing circuitry to execute functions and steps described herein.

An apparatus or system 500, 510 executing a service provider (SP) Network Function Virtualization Management and Orchestration (NFV-MANO) functional entity (FE) (SP FE) operative to execute workload management, comprising processing circuits and a memory, the memory containing instructions executable by the processing circuits whereby the apparatus is operative to:
receive a request for an NFV-MANO service from an NFV-MANO service user (SU);
upon detecting that a threshold indicative of a state of a workload of the SP FE is crossed, determine a priority of the request for the NFV-MANO service and determine, based on the priority and the workload of the SP FE, whether to accept or reject the request; and
send a response to the SU indicative of whether the request is accepted or rejected.

The apparatus (HW) or system 500, 510 is further operative to execute any of the steps and/or functions described herein.

A non-transitory computer readable media 505 having stored thereon instructions 507 for workload management, executed by a service provider (SP) Network Function Virtualization Management and Orchestration (NFV-MANO) functional entity (FE) (SP FE), the instructions comprising:
receiving a request for an NFV-MANO service from an NFV-MANO service user (SU);
upon detecting that a threshold indicative of a state of a workload of the SP FE is crossed, determining a priority of the request for the NFV-MANO service and determining, based on the priority and the workload of the SP FE, whether to accept or reject the request; and
sending a response to the SU indicative of whether the request is accepted or rejected.

The non-transitory computer readable media 505 may contain further instructions to execute any of the functions or steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. Although specific terms may be employed herein, they are used in a generic and descriptive sense only and not for purposes of limitation.

1. A method for workload management, executed by a service provider (SP) Network Function Virtualization Management and Orchestration (NFV-MANO) functional entity (FE) (SP FE), comprising:
receiving a request for an NFV-MANO service from an NFV-MANO service user (SU);
upon detecting that a threshold indicative of a state of a workload of the SP FE is crossed, determining a priority of the request for the NFV-MANO service and determining, based on the priority and the workload of the SP FE, whether to accept or reject the request; and
sending a response to the SU indicative of whether the request is accepted or rejected.

2. The method of claim 1, wherein the threshold is set in advance.

3. The method of claim 1, wherein the threshold is used for determining if the SP FE is in a state of overload.

4. The method of claim 1, wherein the threshold is used for determining if a scale out is warranted.

5. The method of claim 1, wherein the threshold comprises a set of thresholds.

6. The method of claim 5, wherein the set of thresholds comprises a plurality of scale out thresholds associated with different scaling levels, used for determining a warranted scale out level.

7. The method of claim 5, wherein the set of thresholds comprises the threshold used for determining if the SP FE is in a state of overload.

8. The method of claim 1, wherein a logic is used to determine whether to accept or reject the request.

9. The method of claim 1, wherein determining the priority of the request comprises determining that the request has a high priority or a low priority.

10. The method of claim 9, wherein determining that the request has a high priority or a low priority is done using a priority scale.

11. The method of claim 1, wherein determining the priority of the request and determining whether to accept or reject the request depends on a priority of the SU, a type of the requested service or operation, or a combination thereof.

12. The method of claim 1, wherein determining whether to accept or reject the request depends on an escalation mechanism evaluating how close the workload is to a maximum load and having increasingly higher priority cut off values for increasingly higher workloads.

13. The method of claim 12, wherein the escalation mechanism increases a number of rejected requests with increasing workload.

14. The method of claim 12, wherein the escalation mechanism increasingly rejects requests needing a high capacity with increasing workload.

15. The method of claim 1, wherein an output of determining the priority and determining whether to accept or reject the request takes the form of: a single binary or non-binary value, a vector of values, or a data structure.

16. The method of claim 1, wherein determining whether to accept or reject the request comprises producing a predicted time to run for the service request and a predicted capacity that needs to be protected, to be used for determining whether to accept or reject the request.

17. The method of claim 1, wherein the priority is determined using a logic.

18. The method of claim 17, wherein the logic takes the form of a policy, a script, a decision tree, or a machine learning algorithm.

19. The method of claim 17, wherein logic for determining the priority of the request produces a value for a timer, that is sent to the SU along with a response indicative that the request is rejected.

20. The method of claim 19, wherein the SP FE receives the request for the NFV-MANO service from the SU again, after a delay of at least the timer.

21. An apparatus executing a service provider (SP) Network Function Virtualization Management and Orchestration (NFV-MANO) functional entity (FE) (SP FE) operative to execute workload management, comprising processing circuits and a memory, the memory containing instructions executable by the processing circuits whereby the apparatus is operative to:
receive a request for an NFV-MANO service from an NFV-MANO service user (SU);
upon detecting that a threshold indicative of a state of a workload of the SP FE is crossed, determine a priority of the request for the NFV-MANO service and determine, based on the priority and the workload of the SP FE, whether to accept or reject the request; and
send a response to the SU indicative of whether the request is accepted or rejected.

22. (canceled)

23. A non-transitory computer readable media having stored thereon instructions for workload management, executed by a service provider (SP) Network Function Virtualization Management and Orchestration (NFV-MANO) functional entity (FE) (SP FE), the instructions comprising:
receiving a request for an NFV-MANO service from an NFV-MANO service user (SU);
upon detecting that a threshold indicative of a state of a workload of the SP FE is crossed, determining a priority of the request for the NFV-MANO service and determining, based on the priority and the workload of the SP FE, whether to accept or reject the request; and
sending a response to the SU indicative of whether the request is accepted or rejected.

24. (canceled)
